(19) United States
(12) Patent Application Publication
(10) Pub. No.: US 2008/0129824 A1
(43) Pub. Date: Jun. 5, 2008

(54) SYSTEM AND METHOD FOR CORRELATING OBJECTS IN AN EVENT WITH A CAMERA

(76) Inventor: Ryan Scott Loveless, Frisco, TX (US)

Correspondence Address: RYAN LOVELESS, 7864 Stone River Dr., Frisco, TX, 75034, US

(21) Appl. No.: 11/744,593

(22) Filed: May 4, 2007

Related U.S. Application Data
(60) Provisional application No. 60/746,637, filed on May 6, 2006.

(51) Int. Cl. H04N 7/18

(52) U.S. Cl. 348/157; 348/E05.085

(57) ABSTRACT

According to one embodiment of the invention, a method of correlating objects in an event with a camera comprises determining at least a two-dimensional temporal location of an object. A statistical analysis based upon the at least a two-dimensional temporal location of the object is conducted, yielding semantics of the location of the object in relation to the event. A two-dimensional temporal spatial view of a camera is determined and when the semantics represent an item of interest, at least a portion of the at least a two-dimensional temporal spatial view of the camera is correlated with the at least a two-dimensional temporal location of the object to capture the item of interest.

### CROSS-REFERENCE TO RELATED APPLICATIONS

Pursuant to 35 U.S.C. §119 (e), this application claims priority from U.S. Provisional Patent Application Ser. No. 60/746,637, entitled FRAMEWORK FOR AN AUTOMATIC HIGH-LEVEL SEMANTIC RECOGNITION OF SPORTING EVENTS, filed May 6, 2006. U.S. Provisional Patent Application Ser. No. 60/746,637 is hereby incorporated by reference.

### TECHNICAL FIELD OF THE INVENTION

This invention relates generally to the field of semantic interpretation of events and, more particularly, to a system and method for correlating objects in an event with a camera.

### BACKGROUND OF THE INVENTION

A variety of techniques have been used to detect higher-level semantics of video content. However, such techniques lack the robustness desired for commercial settings.

### SUMMARY OF THE INVENTION

According to one embodiment of the invention, a method of correlating objects in an event with a camera comprises determining at least a two-dimensional temporal location of an object. A statistical analysis based upon the at least a two-dimensional temporal location of the object is conducted, yielding semantics of the location of the object in relation to the event. A two-dimensional temporal spatial view of a camera is determined and when the semantics represent an item of interest, at least a portion of the at least a two-dimensional temporal spatial view of the camera is correlated with the at least a two-dimensional temporal location of the object to capture the item of interest.

Certain embodiments of the invention may provide numerous technical advantages. For example, a technical advantage of one embodiment may include the capability to determine a three-dimensional temporal location of an object using RF location devices. Other technical advantages of other embodiments may include the capability to determine a three-dimensional temporal spatial view of a camera using RF location devices. Yet other technical advantages of other embodiments may include the capability to determine whether the a three-dimensional temporal location of an object is correlated with a three-dimensional temporal spatial view of the camera. Still yet other technical advantages of other embodiments may include the capability to yield based upon a statistical analysis of a two-dimensional temporal location of the object, semantics of the location of the object in relation to the event.

Although specific advantages have been enumerated above, various embodiments may include all, some, or none of the enumerated advantages. Additionally, other technical advantages may become readily apparent to one of ordinary skill in the art after review of the following figures and description.

### BRIEF DESCRIPTION OF THE DRAWINGS

For a more complete understanding of example embodiments of the present invention and its advantages, reference is now made to the following description, taken in conjunction with the accompanying drawings, in which:

FIG. 1 shows an embodiment of a general purpose computer that may be used in connection with one or more pieces of software and/or hardware employed by other embodiments of the invention;

FIG. 2 shows a graphical illustration of the ideal distance between two respective nodes;

FIG. 3 illustrates an assisted global positioning system, which may be used according to an embodiment of the invention;

FIGS. 4 and 5 depicts a method for handling a timing issues for object positioning, according to an embodiment of the invention;

FIG. 6 illustrates a configuration for tracking players, a ball and other items such as line markers and officials, according to an embodiment of the invention

FIGS. 7A and 7B illustrate the use of RF tags to determine a temporal spatial view of a camera, according to embodiment of the invention;

FIGS. 8A and 8B illustrate a simple technique for detecting zoom, according to an embodiment of the invention;

FIG. 9 illustrates this spatial view detection phenomena, showing multiple players and a ball in a two-dimensional spatial view of cameras; and

FIG. 10 illustrates the spatial view detection phenomena, showing two players and a ball in a three-dimensional spatial view of a camera.

### DETAILED DESCRIPTION OF EXAMPLE EMBODIMENTS OF THE INVENTION

It should be understood at the outset that although example embodiments of are illustrated below, other embodiments may be implemented using any number of techniques, whether currently known or in existence. The invention should in no way be limited to the example embodiments, drawings, and techniques illustrated below, including the embodiments and implementation illustrated and described herein. Additionally, the drawings are not necessarily drawn to scale.

The description and figures below will make reference to one particular application of certain embodiments of the inventions: sports video and sporting events. Although such example references will be provided, it should be understood that various embodiments of the invention may be applied in other applications.

The business of sports is a multi-billion dollar industry in the United States. According to the Sports Business Journal, in 2005 companies spent an estimated $7 billion in obtaining media broadcast rights for sporting events and another $23 billion on advertisements (e.g., commercials) displayed during such sporting events. Leading the way in collection of fees for media broadcast rights was NFL football. The chart below past recent fee arrangements associated with NFL media contracts.

| Broadcast Media | Entity | Fee |
|---|---|---|
| Cable: Monday Night Football | ESPN | $1.1 billion/year |
| Network Broadcast | ABC, CBS, FOX | $2.2 billion/year |
| Satellite | DirecTV | $0.7 billion/year |

These companies spend so much money because they recognize the value associated with the viewing of captivating sporting events. Given the value attributed to the viewing of such sporting events and the fact that video is the predominant medium for broadcasts, teachings of certain embodiments of the invention recognize a system and method that can automatically and robustly obtain information on the semantics displayed by sporting event video streams. Teachings of certain embodiments of the invention recognize a system and method for detecting semantics of objects in sporting events. Teachings of certain embodiments of the invention recognize that a sports video is simply a real world sporting event viewed through an audio/visual window (e.g., camera) selected by a variety of people, including producers, camera men, network studios, and the like. Additionally, teaching of certain embodiments a recognize a system and method to determine the three-dimensional location of objects in a sporting event. Additionally, teaching of certain embodiments a recognize a system and method to determine the three-dimensional space which a particular window (e.g., a camera) views. Furthermore, teaching of certain embodiments a recognize a system and method that correlates the above two items to ascertain the objects of the sporting event in a spatial/temporal relation to the windows which observes the sporting event.

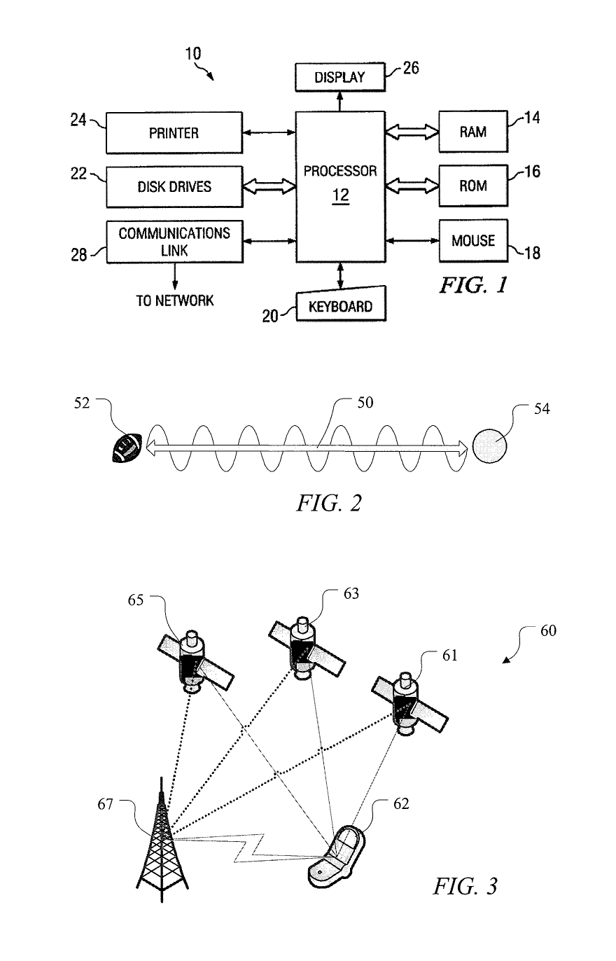

FIG. 1 shows an embodiment of a general purpose computer 10 that may be used in connection with one or more pieces of software and/or hardware employed by other embodiments of the invention. General purpose computer 10 may be adapted to execute any of the well-known OS2, UNIX, Mac-OS, Linux, and Windows Operating Systems or other operating systems. The general purpose computer 10 in the embodiment of FIG. 1 comprises a processor 12, a random access memory (RAM) 14, a read only memory (ROM) 16, a mouse 18, a keyboard 20 and input/output devices such as a printer 24, disk drives 22, a display 26 and a communications link 28. In other embodiments, the general purpose computer 10 may include more, fewer, or other component parts.

Embodiments of the present invention may include programs that may be stored in the RAM 14, the ROM 16, disk drives 22, or other suitable memory and may be executed by the processor 12. The communications link 28 may be connected to a computer network or a variety of other communicative platforms including, but not limited to, a public or private data network; a local area network (LAN); a metropolitan area network (MAN); a wide area network (WAN); a wireline or wireless network; a local, regional, or global communication network; an optical network; radio communications; a satellite network; an enterprise intranet; other suitable communication links; or any combination of the preceding. Disk drives 22 may include a variety of types of storage media such as, for example, floppy disk drives, hard disk drives, CD ROM drives, DVD ROM drives, magnetic tape drives or other suitable storage media. Although this embodiment employs a plurality of disk drives 22, a single disk drive 22 may be used without departing from the scope of the invention.

Although FIG. 1 provides one embodiment of a computer that may be used with other embodiments of the invention, other embodiments of a computer may additionally utilize computers other than general purpose computers as well as general purpose computers without conventional operating systems. Additionally, embodiments of the invention may also employ multiple general purpose computers 10 or other computers networked together in a computer network. Most commonly, multiple general purpose computers 10 or other computers may be networked through the Internet and/or in a client/server network. Embodiments of the invention may also be used with a combination of separate computer networks each linked together by a private or a public network.

Several embodiments of the invention may include logic contained within a computer-readable medium. In the embodiment of FIG. 1, the logic comprises computer software executable on the general purpose computer 10. The medium may include the RAM 14, the ROM 16 or the disk drives 22. In other embodiments, the logic may be contained within hardware configuration or a combination of software and hardware configurations. The logic may also be embedded within any other suitable medium without departing from the scope of the invention.

FIGS. 2-5 shows systems and method that may be utilized for determining the temporal location of an object, according to embodiments of the invention. As indicated above, to semantically ascertain what is being viewed through a particular window (e.g., a camera) at a particular point in time, it is desirable to know the spatial-temporal location of not only the players, but also the ball and other objects important to the game. To this end, a variety of systems may be utilized to determine the temporal location of object, according to embodiments of the invention. Certain embodiments utilize propagated electromagnetic waves to determine the three-dimensional location of such objects as described below.

FIG. 2 shows a graphical illustration of the ideal distance 50 between two respective nodes 52 and 54. By calculating the distance between a transmitter 52 (e.g., located in a ball or helmet) to a plurality of sensing tower or nodes, for example node 54, the location of the transmitter 52 can be detected. The ideal distance 50, d_{ideal}, between two respective nodes, for example, a base station 54 and a football 52 shown in FIG. 2 may be represented as follows:

d_{ideal}=c·t

where c is the is the velocity of electromagnetic waves, defined as:

$$c = 299 \text{,} 792 \text{,} 458 \frac{m}{s}$$

and t is the time it take the electromagnetic waves radio to travel the ideal distance, d_{ideal}.
In the ideal equation, measurement of time, t, is simply:

t=timeₐᵣᵣᵢᵥₐₗ−timeₛₑₙₜ

A problem with time measurement arises when one considers that the object transmitting the electromagnetic wave is different than the object receiving the electromagnetic wave. One microsecond (10⁻⁶ seconds) of error in synchronization between the two can produce the following error:

10⁻⁶s·c=299.792 m

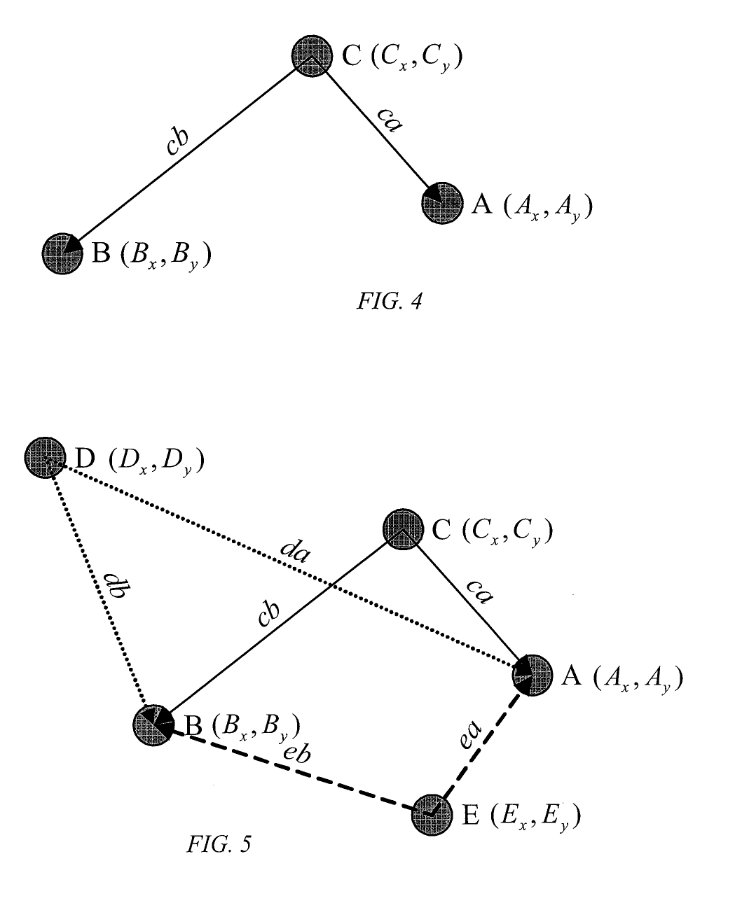

Thus, measurement of timing is important. FIGS. 3-4 and associated discussion provide systems that may be used to handle timing, according to an embodiment of the invention.

FIG. 3 illustrates an assisted global positioning system 60, which may be used according to an embodiment of the invention. Global Positioning Systems (GPS) handles timing rather well, using a GPS synchronization clock. However, historical difficulties with GPS include (1) a line of sight requirement to obtain signals, and (2) a time required to obtain location information. To at least partially mitigate these concerns, certain embodiments may use an assisted global positioning system. A Qualcom company called SnapTrack currently markets an “assisted GPS” technology known as GPSONE.

As shown in FIG. 3, the assisted global positioning system 60 detects the distance between a mobile phone 60 and GPS satellites 61, 63, and 65. In the assisted global positioning system 60, both a network tower 67 and the mobile phone 62 obtain signaling information from the GPS satellites 61, 63 and 65. The network tower 67 can determine signaling/timing errors from the GPS satellites 61, 63, and 65 and communicate corrections to the mobile phone 62. Using the signal from the GPS satellites 61, 63, and 67 and the correction signal from the network tower 67, the location of the mobile phone 62 can be determined.

In particular embodiments, rather than communicate with satellites, another system and method that may utilized more localized sensors, for example, on a tower such a cell tower or the like. Companies that have use localized RF sensing include TKS, Inc of Everett, Mass. (www.trakus.com); TruePosition, Inc. of Berwyn, Pa. (www.trueposition.com); and Cell-Loc Location Technologies of Calgary, AB Canada (www.cell-loc.com). To handle sensitivity with timing issues, Trakus, TruePosition, and Cell-Loc all use techniques that observe a time difference between receipt of signals (either at towers or at the mobile device). However, even with this observed time difference, the mobile device or the towers need to have access to a highly accurate clock. One technique for keeping such an accurate clock, according to an embodiment, is to tap into the GPS clock used for the GPS system for synchronization.

FIGS. 4 and 5 depicts a method for handling a timing issues for object positioning, according to an embodiment of the invention. In the method of FIGS. 4 and 5, timing of signals may be algorithmically removed based on various measurements. The method is based partially on algorithms described in Patent Cooperation Treaty printed publication numbers. WO00/73814, WO00/73814, and WO2004/02103, all of which list Cambridge Positioning Systems, LTD. as applicant (“Cambridge”).

As seen in FIG. 4, one may seek to determine the location of node C (which could be a football or a player) in a system with Nodes A, B, and C. Nodes A and B may be sensing towers or nodes.

In this system, Node C transmits a single signal which is received by Nodes A and B, which are respectively at distances cb and ca from node C. Using a modification of ideal distance equation from above, one may define the time it takes an electromagnetic wave to propagate from Node C to Node A as:

$${t}_{CA} = \frac{\sqrt{{( {C}_{x} - {A}_{x} )}^{2} + {( {C}_{y} - {A}_{y} )}^{2}}}{v} + {α}_{C} + {ɛ}_{A}$$

where α_{c} is defined as Node's A transmission drift from a perfect clock and ε_{A} is Node A's receipt drift from a perfect clock. For purposes utilized herein, “drifts” will refer to how far off a device's clock is from a true perfect time. Assuming that Node B's location (Bₓ,B_{y}) is at (0,0), one may define the time it takes an electromagnetic wave to propagate from Node C to Node B as:

$${t}_{CB} = \frac{\sqrt{{( {C}_{x} + {C}_{y} )}^{2}}}{v} + {α}_{C} + {ɛ}_{B}$$

where ε_{B} Node B's receipt drift from a perfect clock. Letting ε=ε_{A}−ε_{B}, the sum of the receipt drifts, we may define the difference in time receipt of the signals from Node C as follows:

$$Δ {t}_{C} = {t}_{CA} - {t}_{CB} = \frac{\sqrt{{( {C}_{x} - {A}_{x} )}^{2} + {( {C}_{y} - {A}_{y} )}^{2}} - \sqrt{{( {C}_{x} + {C}_{y} )}^{2}}}{v} + ɛ$$

### As can be seen above, the transmission drift ac washes out.

In FIG. 5, two additional Nodes D and E (e.g., other players) are added to the system shown in FIG. 4. If Node D and E operate in a similar manner to Node C—that is, transmitting signals that are received by Nodes A and B, one may define differentials in the receipts of signals from Nodes D and E by Nodes A and B as follows:

$$Δ {t}_{D} = {t}_{DA} - {t}_{DB} = \frac{\sqrt{{( {D}_{x} - {A}_{x} )}^{2} + {( {D}_{y} - {A}_{y} )}^{2}} - \sqrt{{( {D}_{x} + {D}_{y} )}^{2}}}{v} + ɛ$$

$$Δ {t}_{E} = {t}_{EA} - {t}_{EB} = \frac{\sqrt{{( {E}_{x} - {A}_{x} )}^{2} + {( {E}_{y} - {A}_{y} )}^{2}} - \sqrt{{( {E}_{x} + {E}_{y} )}^{2}}}{v} + ɛ$$

If we measure Δt_{C}, Δt_{D} and Δt_{E} and know the location of at least three of these Nodes, for example, Cₓ, C_{y}, Dₓ, D_{y}, Eₓ, and E_{y}, we are left with three unknowns (Aₓ, A_{y}, and ε) and three equations which will converge to two solutions. We can simply introduce another node (e.g., another player) for another measurements for four equations and three unknowns to derive one solution.

Thus, as can be seen above using the method above, one may know nothing about timing at any of the nodes—only relative time receipts, and may still derive a location. Thus, according to this method, the use of receipt of information from multiple nodes (e.g., multiple players and the football) helps the determination of the location of the players.

It should be noted that the above equations defined Node B's location (Bₓ,B_{y}) as (0,0); therefore, Node A's location would be relative to the (0,0) of Node B. Inserting actual values in for Node B, we can determine Node A's location. If Node B's location is unknown, the model may be modified utilizing some of the techniques described below.

The above method shown with reference to FIGS. 4 and 5 may also be used to correct timing drifts where timing is desired. Thus, the method shown with reference to the embodiment of FIGS. 4 and 5 may be used in conjunction with other embodiments described herein in which timing is a factor for the system. For example, for the method shown with the embodiments of FIGS. 4 and 5 may be used to synchronize clocks in other systems over time.

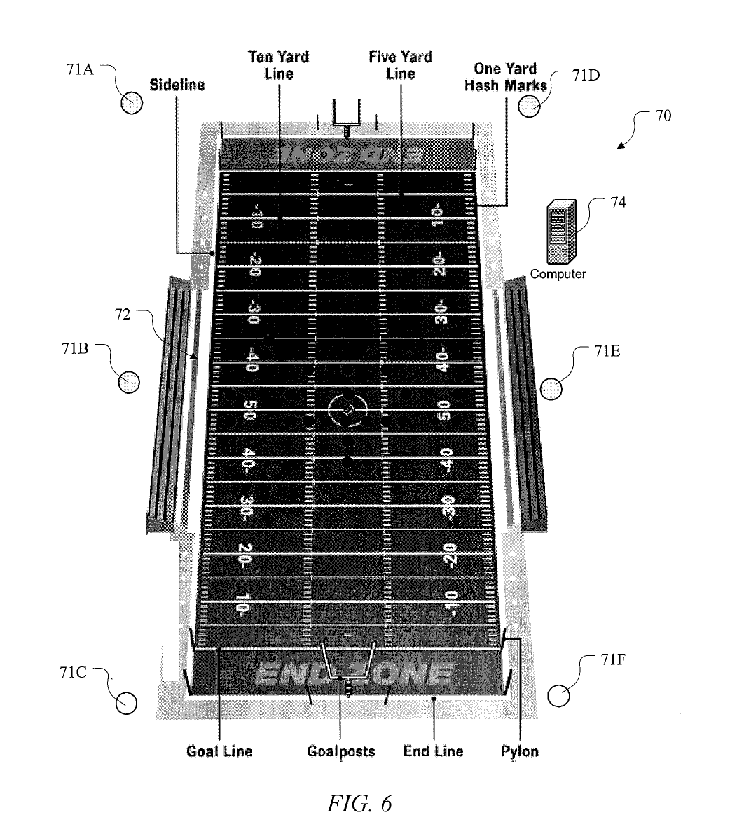

FIG. 6 illustrates a configuration 70 for tracking players, a ball (generally indicated by arrow 72), and other items such as line markers and officials, according to an embodiment of the invention. Each respective player may have a distinct RF tag embedded either within a portion of their uniform—e.g., a helmet or within one or both shoes. One of two types of RF tags can be utilized in particular embodiments: (1) a tag which continuously issues a beacon signal, requiring a power source, and (2) tags which reflect electromagnetic wave. In either scenario the beacon signal or reflected signal from each player and the ball will be received by at least four of six respective nodes 71A, 71B, 71C, 71D, 71E, and 71F. In particular embodiments, the signal is received by at least four nodes to determine a three-dimensional position of the player. The information from each respective node can be processed by a computer.

In particular embodiments, all or portions of the field can be modeled with specific three-dimensional locations. For example, in particular embodiments, one can take a GPS device or other localized RF tags and mark the three-dimensional location of the Goal Posts, End Zone, 10-Yard Line, 20-Yard Line, etc.

These items brought together produce a system in which the players identification along with playing position could be placed into a three-dimensional spatial-temporal location.

In some configurations, techniques described by SportsUniversal Process of France and SportVision of NewYork, which both detect location using cameras, can be used in conjunction with a tag/electromagnetic wave location determination system to determine a location of objects. In other configurations, the systems of SportsUniversal Process of France and SportVision of NewYork can be used separate from a tag/electromagnetic wave determination system to determine the location of objects in a tagless manner. Descriptions of the systems of SportsUniversal Process of France and SportVision of NewYork are described in U.S. Provisional Patent Application Ser. No. 60/746,637, which is hereby incorporated by reference.

According to particular embodiments, the location of the players, ball, and other items during the game, can be semantically ascertained using statistical modeling. In some of such statistical modeling embodiments stochastic processes and hidden Markov models may be utilized. This statistical modeling in particular embodiments can determine what is happening based purely on the location of certain items. Descriptions of these systems are described in U.S. Provisional Patent Application Ser. No. 60/746,637, which is hereby incorporated by reference. The chart below gives example indicators for different events or items in a football game.

| Event/Item | Indicator |
|---|---|
| Line of Scrimmage | Location of line markers |
| Start of Play | Location of players with respect to line of |
| | scrimmage |
| Running Play | Location of ball is the same as the location of |
| | running back |
| Pass Play | Location of ball at quarterback, then moves |
| | vertically in air |
| Successful | Ball reaches location of receiver coupled with |
| Completion | movement of line of scrimmage |
| Penalty | Official in the middle of field coupled with |
| | movement of line of scrimmage |
| Punt | Ball moves to punter and then vertically into |
| | air |
| Field Goal Attempt | Ball moves from kicker and then vertically |
| | into the air |
| Successful Field | Movement of through plane created by |
| Goal | location identified field goal markers |
| Touchdown | Movement into end zone coupled with |
| | placement of at kickoff location at subsequent |
| | time |
| Fumble | Erratic movement of ball and indication of |
| | scrambling by players |

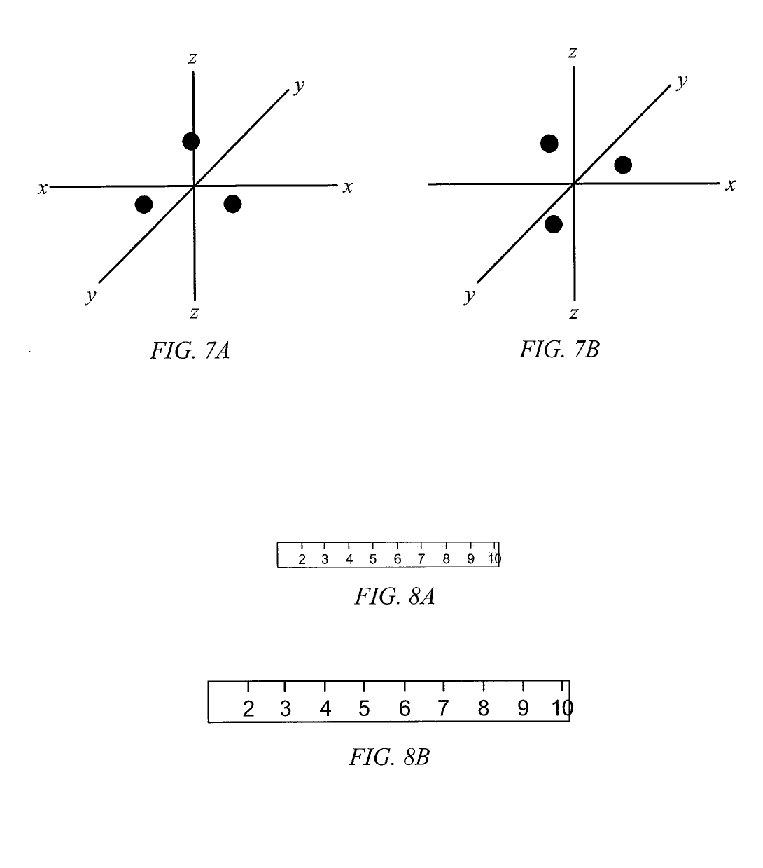

FIGS. 7A-10 shows systems and method for determining a temporal spatial view of a camera, according to embodiments of the invention. In particular embodiments, the spatial view of a camera may be determined using gyroscopes and inclinometers, for example using techniques described in U.S. Pat. No. 6,965,397. In other embodiments, such as those described below, RF tags may be used. These tags (e.g., three or four tags on the camera) can detect the tilt, pan, and movement of the cameras, using location determination techniques, including those described above. With a calibrated RF tag calibrated camera, one can ascertain the three-dimensional space in the field of view of the camera. And, having this field of view or window, one may determine know the precise positioning of each player within the field of view.

FIGS. 7A and 7B illustrate the use of RF tags to determine a temporal spatial view of a camera, according to embodiment of the invention. To calibrate cameras, which in particular embodiments may be traditional cameras, three or more tags may be placed on the cameras to record the cameras movement along six degrees of freedom (e.g., pan and tilt). As seen in FIGS. 7A and 7B, the three dots representing RF tags or RF devices on the camera are moved from the position in FIG. 7A to the position of 7B. Accordingly, the position of the camera is detected. Using such RF tags, movement of a camera can also be detected when the axis of the camera is moved, for example, when not positioned on a tripod. Thus, a mobile cameraman can take the camera, for example, onto the field and the spatial view of the camera can still be detected.

FIGS. 8A and 8B illustrate a simple technique for detecting zoom, according to an embodiment of the invention. With reference to FIGS. 8A and 8B and knowing the distances between respective units on a strip, we can detect the current zoom of the camera. The strip can be removed from actual production view. In other embodiments, the zoom of a camera can be detected using the internal calibration of a camera's parameters or utilizing the special calibration of cameras described in U.S. Pat. No. 6,965,397.

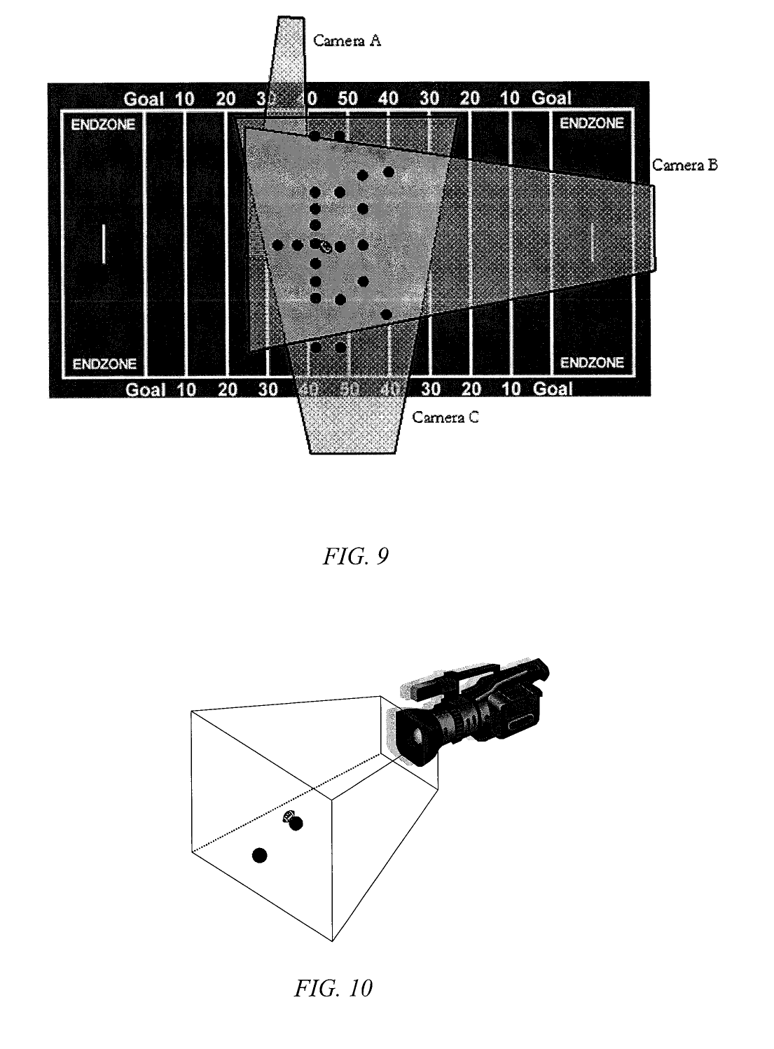

FIG. 9 illustrates this spatial view detection phenomena, showing multiple players and a ball in a two-dimensional spatial view of cameras A, B, and C.

FIG. 10 illustrates the spatial view detection phenomena, showing two players and a ball in a three-dimensional spatial view of a camera.

In particular embodiments, data on detected location of objects and data on spatial views of camera can be stored. Then, a virtual limitless number of queries can be conducted on the data. For example, a query can be ran, asking for clips showing all touchdowns by a particular running back. The system can first ascertain such events using the spatial-temporal location information described in the above embodiments. With this information, the system can then query which camera captured the spatial-temporal location of the objects associated with the events. Specific queries can be limited to certain cameras, such as cameras that were used in a broadcast, or camera that display the best view of the particular event.

In particular embodiments, the system also be used for the real-time production of a game. That is, the system in real-time knows what each camera in a particular game is viewing. Accordingly, using a statistical analysis, the system can automatically switch to the camera that displays the best view of what is happening in the game. Additionally, the spatial view of the cameras can be modified to best capture items of interest in the game as semantically determined from a statistical analysis of the locations of objects in the game.

Particular embodiments may be portable in which components of the system are taken into a particular stadium to record a three-dimensional location of the players. For example, players may be assigned tags that are easily located on some portion of their uniform or equipment and various wireless receivers can be placed at locations around the stadium. Balls, equipped with tags, can be provided. Calibration of traditional cameras may be conducted using the above-referenced techniques.

In particular embodiments, are a variety of types of devices that can be used to transmit an electromagnetic signal. Additionally, in particular embodiments multiple tags can be placed on a single object to increase a confidence of the three-dimensional location assigned to the single object. In such an embodiment, an independent determination of the location of each tag on the single object can be determined. Then, the system can analyze a distance between each tag on the single object as detected. Generally, the smaller deviation from a true distance between the tags on the single entity, the higher the confidence for location of the tags that represent the entity or object.

Besides the above mentioned uses of particular embodiments of the invention, there are a virtual limitless other uses that can avail from particular embodiments. Example uses that can be include, but are not limited to, stats generation, real-time video production assistance, viewing enhancement, refereeing, and sports analysis.

### Production System

In particular embodiments, indicators may be given to producers as to the best camera to view the events that are occurring, for example as may be determined by a statistical analysis of location of objects. Additionally, in particular embodiments, all or portion of the production may be automated, switching between cameras that are statistically determined to be the best camera for production, and instructing camera to modify their spatial view as necessary to best capture the items of interest in the production. Furthermore, in particular embodiments, the cameras can be automated to track the ball and/or players and zoom on the occurrence of certain events.

### Viewing Enhancements

Particular embodiments may also provide a variety of onscreen viewing enhancements, displaying certain statistical information, including the speed of a particular player or ball, the “hang time” and/or height for a punted ball, and the vertical height a player jumps in a particular event. Additionally, in particular embodiments, statistics which are typically manually generated may be automated. For example, particular embodiments may automatically determine the current state of play that should be displayed on a screen is, for example, 2nd down, 4 yards to go.

### Refereeing Assistance System

Particular embodiments may also be utilized as a refereeing assistance system. For example, with regards to football, embodiments may detect offside movement of a player with respect to a line of scrimmage. Additionally, instead of a referee visually ascertaining whether or not a field goal is good, embodiments may determine whether the kicked ball passes the plane created by the upright, issuing, for example, on a screen: “Good,” “No Good”, “No Good—ten feet to the left,” or an entertaining “Not even close.”

### Customized Viewing Experience

As referenced above, particular embodiments may provide a fully automated production could occur. And, users in some of the embodiments may be allowed to deviate from that production at their own choosing. For example, the fully automated production would choose camera shots that are believed to give the best display of a particular event. However, a user may be allowed to deviate and choose the shots they actually want to view. In this customized viewing experience, a simulcast could be displayed, show a modeled view of what is happening and the actual selected view as chosen by the user.

As one example of the above embodiment, a modeled layout could be displayed along with cameras that can be selected, showing the current position of the camera. A user may select which camera they would like to view.

### Game Analysis

Embodiments may also be used in the analytic determination of game play by both players and coaches alike. 3-D models can be created to simulate what is happening in the game. And, having such a 3-D model virtual views of what is happening in game play can be analyzed. These virtual views can give a perspective that may not actually be available in the video footage. For other views in which actual video footage exists, a simulcast of the model and the actual video may be displayed at the same time.

Additionally, in particular embodiments analyzing game play, a variety of queries can be conducted such as: how many times was a particular play ran? What types of plays scored most often? What is the most common formation and success associated with that formation? Are all the players actually playing to the end of play? What is the effective speed for players throughout the game?

Although the present invention has been described with several embodiments, a myriad of changes, variations, alterations, transformations, and modifications may be suggested to one skilled in the art, and it is intended that the present invention encompass such changes, variations, alterations, transformation, and modifications as they fall within the scope of the appended claims.

What is claimed is:

1. A system for correlating objects in an event with a camera, the system comprising:
computer readable media such that when executed is operable to:
determine at least a two-dimensional temporal location of an object;
determine at least a two-dimensional temporal spatial view of a camera; and
determine whether the at least a two-dimensional temporal location of the object is correlated with the at least a two-dimensional temporal spatial view of the camera.

2. The system of claim 1, wherein
the at least a two-dimensional temporal location of the object is a three-dimensional temporal location of the object, and
the at least a two-dimensional temporal spatial view of the camera is a three-dimensional temporal spatial view of the camera.

3. The system of claim 1, wherein the computer readable media such that when executed is further operable to:
yield based upon a statistical analysis of the two-dimensional temporal location of the object, semantics of the location of the object in relation to the event; and
when the semantics represent an item of interest, provide instructions to correlate at least a portion of the at least a two-dimensional temporal spatial view of the camera with the at least a two-dimensional temporal location of the object to capture the item of interest.

4. The system of claim 3, wherein the object is a plurality of objects and the yielding by the executed computer readable media is based upon a statistical analysis of the two-dimensional temporal locations of the plurality of objects.

5. The system of claim 3, wherein the yielding by the executed computer readable media is further based upon a pre-defined set of rules corresponding to the event.

6. The system of claim 3, wherein the yielding by the executed computer readable media is further based upon a pre-defined locations of event parameters.

7. The system of claim 3, wherein the instructions to correlate yield a real-time automatic positioning of the camera.

8. The system of claim 3, wherein the determining by the executed computer readable media of the at least a two-dimensional temporal spatial view of the camera is at least partially carried out using a signal received from at least one radio frequency (RF) location device located on the camera.

9. The system of claim 3, wherein determining by the executed computer readable media of the at least a two-dimensional temporal location of an object is at least partially carried out using a signal received from the at least one radio frequency (RF) location device located on the object.

10. The system of claim 9, wherein the determining by the executed computer readable media of the at least a two-dimensional temporal spatial view of the camera is at least partially carried out using a signal received from at least one radio frequency (RF) location device located on the camera.

11. The system of claim 1, wherein the determining by the executed computer readable media of the at least a two-dimensional temporal spatial view of the camera is at least partially carried out using a signal received from at least one radio frequency (RF) location device located on the camera.

12. The system of claim 1, wherein determining by the executed computer readable media of the at least a two-dimensional temporal location of an object is at least partially carried out using a signal received from the at least one radio frequency (RF) location device located on the object.

13. The system of claim 12, wherein the determining by the executed computer readable media of the at least a two-dimensional temporal spatial view of the camera is at least partially carried out using a signal received from at least one radio frequency (RF) location device located on the camera.

14. The system of claim 1, wherein the executed computer readable media computer in determining the at least a two-dimensional temporal location of the object and determining the at least a two-dimensional temporal spatial view of the camera reviews information in a data store.

15. The system of claim 13, wherein the computer readable media such that when executed is operable to is further operable to:
yield based upon a statistical analysis of the two-dimensional temporal location of the object, semantics of the location of the object in relation to the event; and
when the semantics represent an item of interest, determine for a time period of the item of interest whether the at least a two-dimensional location of the object is correlated with the at least a two-dimensional spatial view of the camera.

16. The method of claim 1, wherein the camera is a plurality of cameras and the computer readable media such that when executed is operable to is further operable to:
yield based upon a statistical analysis of the two-dimensional temporal location of the object, semantics of the location of the object in relation to the event; and
when the semantics represent an item of interest, provide instruction to correlate at least a portion of the at least a two-dimensional temporal spatial view of at least one of the plurality of cameras with the at least a two-dimensional temporal location of the object to capture the item of interest.

17. A method of correlating objects in an event with a camera, the method comprising:
determining at least a two-dimensional spatial view of a camera, wherein the determining at least a two-dimensional spatial view of the camera is at least partially carried out using radio frequency (RF) location devices located on the camera.

18. The method of claim 17, wherein the at least a two-dimensional spatial view is a three-dimensional spatial view.

19. The method of claim 17, further comprising:
determining at least a two-dimensional temporal location of an object

20. The method of claim 17, wherein the determining at least a two-dimensional spatial view of a camera is at least partially carried out using at least three RF location sensors that receive electromagnetic waves from the radio frequency (RF) location devices on the camera.

21. The method of claim 30, wherein determining at least a two-dimensional temporal location of the plurality of object is based upon an up-link time of arrival of propagated waves from the radio frequency (RF) location devices.

22. The method of claim 17, wherein the determining at least a two-dimensional spatial view of the camera includes determining a temporal spatial view of the camera.

23. The method of claim 17, wherein the determining a temporal spatial view of the camera accommodates for movement in the axis of the camera.

24. A method of correlating objects in an event with a camera, the method comprising:
determining a three-dimensional temporal location of an object;
yielding, based upon a statistical analysis of the two-dimensional location of the object and a pre-defined set of rules, semantics of the object in relation to an event.

25. The method of claim 24, further comprising:
determining at least a two-dimensional temporal spatial view of a camera;

26. The method of claim 24, wherein the event is sporting event.

27. The method of claim 24, wherein the statistical analysis includes utilization of a hidden Markov model.

28. The method of claim 24, wherein determining the at least a two-dimensional temporal location of an object is at least partially carried out using radio frequency (RF) location devices on the object.

29. The method of claim 24, wherein the object is a plurality of objects, further comprising:
determining at least a two-dimensional temporal location of the plurality of objects.

30. The method of claim 29, wherein the determining at least a two-dimensional temporal location of the plurality of object is at least partially carried out using radio frequency (RF) location devices.

31. The method of claim 30, wherein each of the plurality of objects has at least two radio frequency (RF) location devices.

32. The method of claim 30, wherein the determining at least a two-dimensional temporal location of the plurality of object is based upon an up-link time of arrival of propagated waves from the radio frequency (RF) location devices.

33. The method of claim 32, wherein the radio frequency devices issue beacon signals which are received by at least four nodes.

34. The method of claim 32, wherein the radio frequency devices issue beacon signals which are received by at least three sensor nodes.

35. The method of claim 34, wherein determining at least a two-dimensional temporal location of the plurality of object is further based upon a measurement of time differentials of propagated electromagnetic waves from different devices.

36. The method of claim 35, wherein the measurement of time differentials of propagated electromagnetic waves from different devices accommodates for a lack of synchronization in the system.

37. The method of claim 29, wherein
the event is sporting event, and
at least one of the plurality of objects is a ball and at least one of the plurality of objects is a player.

38. A method of correlating objects in an event with a camera, the method comprising:
determining at least a two-dimensional temporal location of an object;
determining at least a two-dimensional temporal spatial view of a camera; and
determining whether the at least a two-dimensional temporal location of the object is correlated with the at least a two-dimensional temporal spatial view of the camera.

39. The method of claim 38, wherein
the at least a two-dimensional temporal location of the object is a three-dimensional temporal location of the object, and
the at least a two-dimensional temporal spatial view of the camera is a three-dimensional temporal spatial view of the camera.

40. The method of claim 38, further comprising:
yielding based upon a statistical analysis of the two-dimensional temporal location of the object, semantics of the location of the object in relation to the event; and
when the semantics represent an item of interest, correlating at least a portion the at least a two-dimensional temporal spatial view of the camera with the at least a two-dimensional temporal location of the object to capture the item of interest.

41. The method of claim 40, wherein determining the at least a two-dimensional temporal spatial view of the camera is at least partially carried out using at least one radio frequency (RF) location device located on the camera.

42. The method of claim 40, wherein determining the at least a two-dimensional temporal location of an object is at least partially carried out using at least one radio frequency (RF) location device located on the object.

43. The method of claim 42, wherein determining the at least a two-dimensional temporal spatial view of the camera is at least partially carried out using at least one radio frequency (RF) location device located on the camera.

44. The method of claim 38, wherein determining the at least a two-dimensional temporal spatial view of the camera is at least partially carried out using at least one radio frequency (RF) location device located on the camera.

45. The method of claim 38, wherein determining the at least a two-dimensional temporal location of an object is at least partially carried out using at least one radio frequency (RF) location device located on the object.

46. The method of claim 45, wherein determining the at least a two-dimensional temporal spatial view of the camera is at least partially carried out using at least one radio frequency (RF) location device located on the camera.

47. The method of claim 40, wherein the object is a plurality of objects and the yielding is based upon a statistical analysis of the two-dimensional temporal locations of the plurality of objects.

48. The method of claim 40, wherein the yielding is further based upon a pre-defined set of rules corresponding to the event.

49. The method of claim 40, wherein the yielding is further based upon a pre-defined locations of event parameters.

50. The method of claim 40, wherein the correlating is a real-time automatic positioning of the camera.

51. The method of claim 38, wherein
determining the at least a two-dimensional temporal location of the object and determining the at least a two-dimensional temporal spatial view of the camera are carried out by reviewing information in a data store.

52. The method of claim 51, further comprising:
yielding, with the one or more computers, based upon a statistical analysis of the two-dimensional temporal location of the object, semantics of the location of the object in relation to the event; and
when the semantics represent an item of interest, determining for a time period of the item of interest whether the at least a two-dimensional location of the object is correlated with the at least a two-dimensional spatial view of the camera.

53. The method of claim 38, wherein the camera is a plurality of cameras, further comprising:
yielding based upon a statistical analysis of the two-dimensional temporal location of the object, semantics of the location of the object in relation to the event; and
when the semantics represent an item of interest, correlating at least a portion of the at least a two-dimensional temporal spatial view of at least one of the plurality of cameras with the at least a two-dimensional temporal location of the object to capture the item of interest.

54. A system for correlating objects in an event with a camera, the method comprising:
a camera having radio frequency (RF) location devices and a focus detector,
at least three RF location sensors that receive electromagnetic waves to or from the radio frequency (RF) location devices on the camera; and
a computer operable to determine at least a two-dimensional spatial view of the camera based on the receive electromagnetic waves from the radio frequency (RF) location devices and the focus detector.

55. The system of claim 54, wherein the computer is remote from the camera.

56. The system of claim 54, wherein the computer is on-board with the camera.

57. The system of claim 54, wherein the camera at least a two-dimensional spatial view is a three-dimensional spatial view.
